(19) United States
(12) Patent Application Publication
(10) Pub. No.: US 2005/0194728 A1
(43) Pub. Date: Sep. 8, 2005

(54) Vibration-damping coupling device

(76) Inventors: Jacques Molet, Gohory (FR); Christophe Porpe, Serquigny (FR)

Correspondence Address: MCCRACKEN & FRANK LLP, 200 W. ADAMS STREET, SUITE 2150, CHICAGO, IL, 60606, US

(21) Appl. No.: 11/069,401

(22) Filed: Feb. 28, 2005

(30) Foreign Application Priority Data
Mar. 2, 2004 (FR) FR 04 02147

(51) Int. Cl. F16F 3/02

(52) U.S. Cl. 267/151; 267/152; 267/153

(57) ABSTRACT

The invention relates to a vibration-damping coupling device for coupling a vibrating structure element (11) to a non-vibrating structure element (13), said device comprising: an elastomer body (10) provided with two fastening portions (12, 14) each designed to be fastened to a respective one of said elements (11, 13); and a flexible limiter band (22) disposed around the elastomer body (10) and adapted to limit the extent to which the two fastening elements (12, 14) can move relative to each other. The limiter band (22) is stitched to the elastomer body (10) at least over one zone.

The invention relates to a vibration-damping coupling device for coupling together two elements that vibrate relative to each other, e.g. a vehicle exhaust mounting.

More precisely, the invention relates to a vibration-damping coupling device for coupling a vibrating structure element to a non-vibrating structure element, said device comprising:
an elastomer body provided with two fastening portions each designed to be fastened to a respective one of said elements; and
a flexible limiter band disposed around the elastomer body and adapted to limit the extent to which the two fastening elements can move relative to each other.

Current vibration-damping coupling devices such as those described in Document EP-B1-0 816 734 comprise a device of the above-described type having a limiter element that is fastened removably.

In that type of device, the limiter is not fastened to the elastomer body, and therefore might become detached from the elastomer body, giving rise to degradation in the endurance of the elastomer body, or even to said body becoming torn under a traction force that is too large.

A particular object of the present invention is to mitigate that drawback.

To this end, according to the invention, a vibration-damping device of the type in question is characterized in that the limiter band is stitched to the elastomer body at least over one zone.

By means of these provisions, the limiter is assembled to the elastomer body in non-removable manner.

In various embodiments of the device of the invention, it is optionally possible to make use of one or more of the following provisions:
on its circumference, the elastomer body is provided with at least one projecting pad to which the limiter band is stitched; and
the pad is situated in alignment with the fastening portions.

The invention also provides a manufacturing method in which the body and the limiter band are molded independently, the limiter band is positioned around the elastomer body, then the limiter band is stitched to the elastomer body, and finally the assembly formed by the band and by the elastomer body is put in place on the structure elements.

Other characteristics and advantages of the invention appear on reading the following description of an embodiment thereof, given by way of non-limiting example and with reference to the accompanying drawings.

In the drawings:

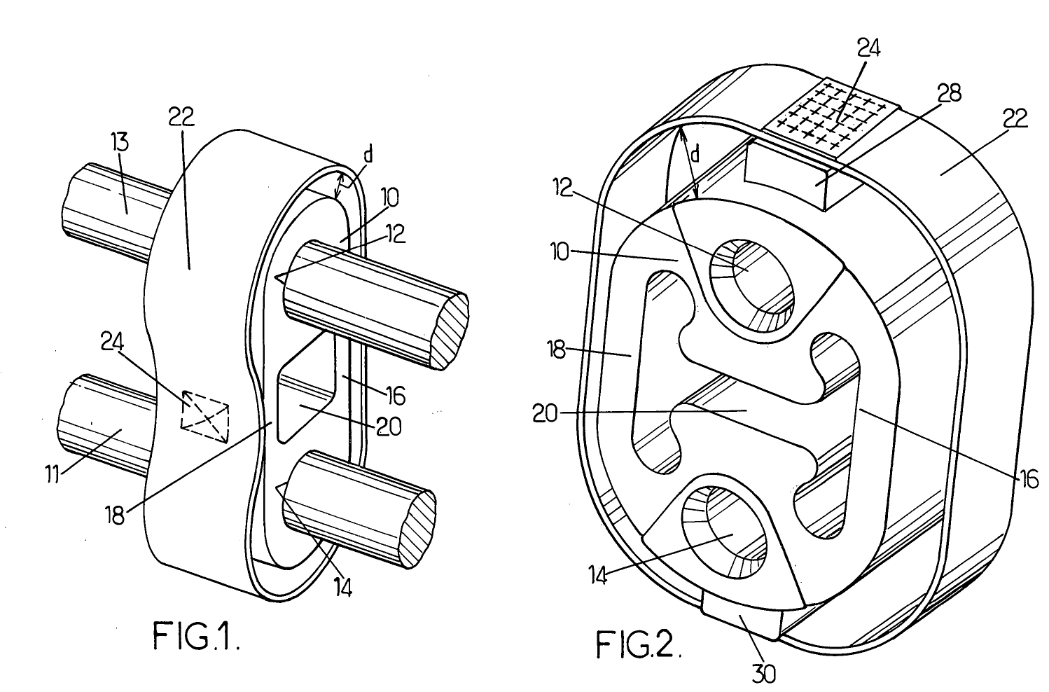

FIG. 1 is a perspective view of a first embodiment of the device of the invention; and

FIG. 2 is a perspective view of a second embodiment of a device of the invention.

In the various figures, like references designate elements that are identical or similar.

As shown in FIG. 1, the vibration-damping coupling device comprises an elastomer body 10 provided with two fastening portions 12, 14 serving to be fastened respectively to a vibrating structure element 11 and to a non-vibrating structure element 13. For example, the vibrating structure element 11 can be an exhaust pipe of a vehicle, and the non-vibrating element 13 can be the body of the vehicle. The vibration-damping coupling device makes it possible to connect the elements together, while damping the motion of the vibrating element 11 relative to the non-vibrating element 13.

Each of the two fastening portions 12, 14 is formed of a circular opening into which a respective portion of the structure elements is inserted. Said openings 12, 14 are disposed at opposite ends from each other in the direction of movement in the elastomer body 10, and they are interconnected by two parallel branches 16, 18 extending in the direction of movement, and defining a central opening 20 formed so as to absorb the vibration.

As shown in FIG. 1, the body 10 of the device is oblong in shape, and the fastening portions 12, 14 are situated at either longitudinal end of said body.

The device further comprises a flexible and oblong limiter band 22 surrounding the elastomer body 10 at a distance d. The band 22 is made of a material, such as Rayon webbing, which is less extensible than the material of the elastomer body 10, so as to limit the extent to which the two structure elements 11, 13 can move relative to each other.

The limiter band 22 is assembled to the elastomer body 10 by means of stitching 24 in order to hold the elastomer body 10 in non-removable manner inside the band 22.

As shown in FIG. 1, the stitching 24 is situated on a longitudinal wall, and substantially equidistantly from the two fastening portions 12, 14. Said stitching 24 puts the bottom face of the limiter band 22 into contact with the outside wall of the elastomer body 10, and secures the limiter band 22 to the elastomer body 20.

The stitching 24 shown in FIG. 1 is a set of stitches forming a rectangle and a cross, and it fastens the limiter band 22 to the elastomer body 10, while also enabling the elastomer body 10 to move inside the limiter band 22 in the longitudinal direction of relative movement. The elastomer body 10 has sufficient elasticity to deform between the stitching zone 24 and the limiter band 22.

Thus, when the elastomer body 22 is subjected to the movements of the structure elements, there is no risk of the limiter band 22 being detached from the elastomer body 10, regardless of the direction of movement.

In FIG. 2, the elastomer body is provided with two pads 28, 30 projecting towards the outside of the elastomer body 10 in alignment with the direction of movement. The pads 28, 30 are of thickness equal to the distance d between the elastomer body and the limiter band. The limiter band 22 is stitched onto the two pads 28, 30 in non-removable manner. As shown in FIG. 2, the stitching 24 is implemented in the form of a grid pattern of crisscrossing stitches over the entire surface of the pad 28, 30. Thus, the limiter band is held to the pads 28, 30 in non-removable manner. By means of these provisions, the elastomer body 10 is not subjected to vibration between the stitching zone and the fastening portion 12, 14, but rather between the two fastening portions 12, 14. The pads 28, 30 are subjected to the traction and compression forces due to the movements of the structure elements. These deformations are limited by the limiter band 22.

The stitching is performed with nylon stitching thread, e.g. of the type used in seatbelts.

The invention also relates to a method manufacturing a vibration-damping coupling device of the invention, which method comprises the steps of molding the elastomer body 10, molding the limiter band 22 in an independent mold, positioning the limiter band 22 around the elastomer body, a step consisting in stitching the limiter band 22 to the elastomer body 10, and finally positioning the coupling device on the structure elements.

The invention is in no way limited to the described embodiments, which are given merely by way of example.

1. A vibration-damping coupling device for coupling a vibrating structure element to a non-vibrating structure element, said device comprising:
an elastomer body provided with two fastening portions each designed to be fastened to a respective one of said elements; and
a flexible limiter band disposed around the elastomer body and adapted to limit the extent to which the two fastening elements can move relative to each other;
said device being characterized in that the limiter band is stitched to the elastomer body at least over one zone.

2. A vibration-damping coupling according to claim 1, characterized in that, on its circumference, the elastomer body is provided with at least one projecting pad to which the limiter band is stitched.

3. A vibration-damping coupling according to claim 2, characterized in that the pad is situated in alignment with the fastening portions.

4. A method of manufacturing a vibration-damping coupling device according to claim 1, characterized in that it comprises the following steps:
molding the elastomer body;
molding the limiter band;
positioning the limiter band around the elastomer body;
stitching the limiter band to the elastomer body; and
putting the device in place on the structure elements
